(19) United States
(12) Patent Application Publication
(10) Pub. No.: US 2024/0214842 A1
(43) Pub. Date: Jun. 27, 2024

(54) TERMINAL AND RADIO COMMUNICATION METHOD

(71) Applicant: NTT DOCOMO, INC., Tokyo (JP)

(72) Inventor: Tianyang Min, Tokyo (JP)

(73) Assignee: NTT DOCOMO, INC., Tokyo (JP)

(21) Appl. No.: 18/555,435

(22) PCT Filed: Mar. 25, 2022
(86) PCT No.: PCT/JP2022/014448

§ 371 Date: Oct. 13, 2023

(30) Foreign Application Priority Data
Apr. 16, 2021 (JP) 2021-070006

(51) Int. Cl. H04W 24/04; H04W 48/16

(52) U.S. Cl. CPC H04W 24/04; H04W 48/16

(57) ABSTRACT

A terminal deactivates a secondary cell group according to a state of the secondary cell group. The terminal also transmits failure information of the secondary cell group to a network. When a failure of the secondary cell group in an inactive state occurs, the terminal transmits failure information including an information element indicating a state of cells of the secondary cell group.

### TECHNICAL FIELD

The present disclosure relates to a terminal and a radio communication method corresponding to dual connectivity.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

In Release-17 of the 3GPP, an expansion of Multi-RAT Dual Connectivity (MR-DC) is considered, for example, a secondary cell group (SCG) activation/deactivation mechanism (may be referred to as SCG activation/deactivation) with the primary objective of reducing power consumption of terminals (User Equipment, UE) (Non-Patent Literature 1).

In addition, for deactivated SCG, it is proposed that the UE to support performing radio link monitoring (RLM), beam fault detection (BFD), etc. in the primary secondary cell (PSCell) (Non-Patent Literature 2).

### CITATION LIST

### Non-Patent Literature

### [Non-Patent Literature 1]

“Revised WID on Further Multi-RAT Dual-Connectivity enhancements,” RP-201040, 3GPP TSG PAN Meeting #88e, 3GPP, June 2020

### [Non-Patent Literature 2]

“UE measurements and reporting in deactivated SCG,” R2-2103893, 3GPP TSG-RAN WG2 Meeting #113-bis-e, 3GPP, April 2021

### SUMMARY OF INVENTION

When a UE executes RLM and/or BFD for cells (including PSCells) included in a deactivated SCG, the following problems are considered. Specifically, the UE can transmit SCG failure information (SCGFailureInformation) to the master node upon detecting a failure in the deactivated SCG, but cannot determine the appropriate content to include in the SCGFailureInformation according to the RLM and/or BFD results.

Therefore, the following disclosure is made in light of this situation, and is intended to provide a terminal and a radio communication method that can provide appropriate deactivated SCG failure information to the network when the RLM and/or BFD are executed.

One aspect of the present disclosure is a terminal including a control unit (control unit 240) that deactivate a secondary cell group according to a state of the secondary cell group, and a transmission unit (DC processing unit 230) that transmits failure information of the secondary cell group to a network. The transmission unit transmits, when a failure of the secondary cell group in an inactive state occurs, the failure information including an information element indicating a state of cells of the secondary cell group.

One aspect of the present disclosure a radio communication method including the steps of a terminal deactivating a secondary cell group according to a state of the secondary cell group and the terminal transmitting failure information of the secondary cell group to a network. In the transmitting step, when a failure of the secondary cell group in an inactive state occurs, the failure information including an information element indicating a state of cells of the secondary cell group is transmitted.

### BRIEF DESCRIPTION OF DRAWINGS

FIG. 1 is an overall schematic diagram of a radio communication system 10.

FIG. 2 is a functional block diagram of an eNB100A.

FIG. 3 is a functional block diagram of a UE200.

FIG. 4 is a diagram showing an example of a communication sequence associated with deactivation of the SCG and detection of a failure of the SCG.

FIG. 5 is a diagram showing an example of information elements related to the deactivated SCG that can be included in SCGFailureInformation.

FIG. 6 is a diagram showing an example of the elapsed time of the TA timer and the elapsed time between the transition of the SCG to the inactive state and the detection of the failure of the SCG.

FIG. 7 is a diagram showing an example of the hardware configuration of the eNB100A, gNB100B and UE200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

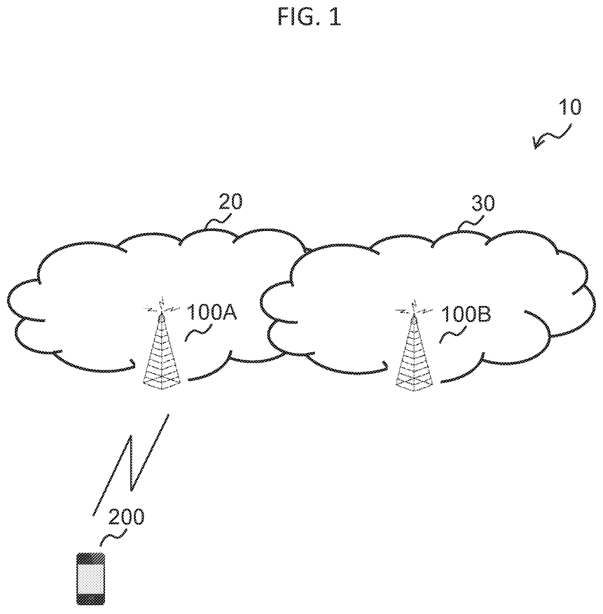

FIG. 1 is an overall schematic configuration diagram of a radio communication system 10 according to the present embodiment. The radio communication system 10 is a radio communication system according to Long Term Evolution (LTE) and 5G New Radio (NR). The LTE may be referred to as 4G or the NR may be referred to as 5G. radio communication system 10 may also be an radio communication system that follows a method called Beyond 5G, 5G Evolution or 6G.

LTE and NR may be interpreted as radio access technology (RAT), in this embodiment LTE may be referred to as the first radio access technology and NR may be referred to as the second radio access technology.

The radio communication system 10 includes Evolved Universal Terrestrial Radio Access Network 20 (E-UTRAN20) and Next Generation-Radio Access Network 30 (NG RAN30). The radio communication system 10 also includes a terminal 200 (UE200, User Equipment).

The E-UTRAN20 includes an eNB100A, which is a radio base station according to LTE. The NG RAN30 includes a gNB100B, which is a radio base station according to 5G (NR). The NG RAN30 may also be connected to a User Plane Function (not shown), which is included in the 5G system architecture and provides user plane functionality. The E-UTRAN20 and NG RAN30 (may be eNB100A or gNB100B) may be referred to simply as networks.

The eNB100A, gNB100B and UE200 may support carrier aggregation (CA) using a plurality of component carriers (CCs) and dual connectivity for simultaneously transmitting component carriers between a plurality of NG-RAN Nodes and a UE.

The eNB100A, gNB100B and UE200 perform radio communication via a radio bearer, specifically a Signalling Radio Bearer (SRB) or a DRB Data Radio Bearer (DRB).

In this embodiment, multi-radio dual connectivity (MR-DC) in which the eNB100A constitutes the master node (MN) and the gNB100B constitutes the secondary node (SN) may be performed, specifically, E-UTRA-NR dual connectivity (EN-DC) may be performed, or NR-E-UTRA dual connectivity (NE-DC) in which the gNB100B constitutes the MN and the eNB100A constitutes the SN may be performed. Alternatively, NR-NR dual connectivity (NR-DC) in which the gNB constitutes the MN and SN may be performed.

Thus, the UE200 corresponds to the dual connectivity connecting the eNB100A and the gNB100B.

The eNB100A is included in the master cell group (MCG) and the gNB100B is included in the secondary cell group (SCG). In other words, the gNB100B is an SN included in the SCG.

The eNB100A and the gNB100B may be referred to as radio base stations or network devices.

Also, the radio communication system 10 may support adding or changing a Primary SCell (PSCell) (PSCell addition/change). The PSCell addition/change may include a conditional PSCell addition/change.

A PSCell is a type of secondary cell. A PSCell means a primary SCell (secondary cell), which may be interpreted as the equivalent of one of several SCells.

The secondary cell may be read as a secondary node (SN) or a secondary cell group (SCG).

### (2) Function Block Configuration of Radio Communication System

Next, the function block configuration of the radio communication system 10 will be described. Specifically, the function block configuration of the eNB100A and UE200 will be described.

(2.1) eNB100A

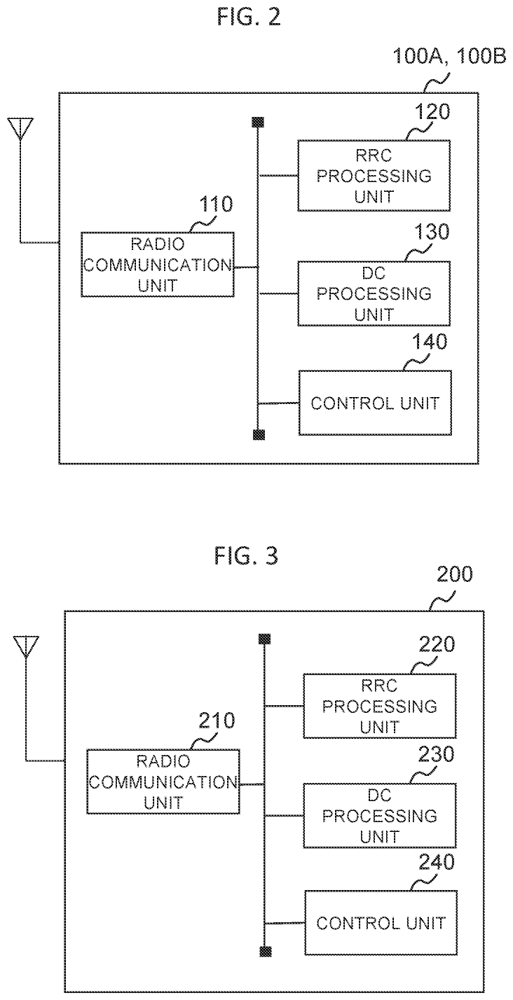

FIG. 2 is a function block configuration diagram of the eNB100A. As shown in FIG. 2, the eNB100A includes a radio communication unit 110, an RRC processing unit 120, a DC processing unit 130, and a control unit 140. The gNB100B may also have the same function as the eNB100A, although the gNB100B is different in that it supports NR.

The radio communication unit 110 transmits a downlink signal (DL signal) in accordance with LTE. The radio communication unit 110 receives an uplink signal (UL signal) in accordance with LTE.

The radio communication unit 110 performs assembly/disassembly of the PDU/SDU in a plurality of layers (Media access control layer (MAC), radio link control layer (RLC), packet data convergence protocol layer (PDCP), etc.).

The RRC processing unit 120 executes various processes in the radio resource control layer (RRC). Specifically, the RRC processing unit 120 can transmit the RRC Reconfiguration to the UE200. The RRC processing unit 120 can receive the RRC Reconfiguration Complete, which is a response to the RRC Reconfiguration, from the UE200.

In this embodiment, the eNB100A supports LTE, but in this case, the name of the RRC message may be RRC Connection Reconfiguration or RRC Connection Reconfiguration Complete.

In addition, the RRC Reconfiguration (and inter-node RRC messages between MN and SN) may include reconfigurationWithSync related to cell reconfiguration. reconfigurationWithSync is specified in 3GPP TS38.331, Section 5.3.5.5.2, etc.

reconfigurationWithSync may be interpreted as a common mechanism for activating cells (In other words, add NR cells) in non-standalone (NSA) including other RATs (such as LTE). UE200 may perform random access procedures (RA procedures), etc. based on reconfigurationWithSync.

The DC processing unit 130 performs processing related to dual connectivity, specifically, Multi-RAT Dual Connectivity (MR-DC). In this embodiment, since eNB100A supports LTE and gNB100B supports NR, DC processing unit 130 may perform processing related to E-UTRA-NR Dual Connectivity (EN-DC). As described above, the type of DC is not limited, and for example, NR-E-UTRA Dual Connectivity (NE-DC) or NR-NR Dual Connectivity (NR-DC) may be supported.

The DC processing unit 130 transmits and receives messages defined by the 3GPP TS37.340, etc., and can execute processing for configuration and releasing DC between the eNB100A, gNB100B, and UE200.

The control unit 140 controls each functional block constituting the eNB100A. In particular, in the present embodiment, the control unit 140 executes control for adding or changing a secondary cell (which may be a secondary node).

Specifically, the control unit 140 can execute control for activating/deactivating (active/de-active) a secondary cell group (SCG). Specifically, the control unit 140 may activate (may be called activating) or deactivate (may be called deactivating) the SCG based on instructions from the UE200. More specifically, control unit 140 may activate or deactivate one or more SCells (May include PSCell, hereinafter the same) included in the SCG.

An active SCG (SCell) may be interpreted as a state in which the UE200 can immediately utilize the SCG (SCell). An inactive SCG (SCell) may be interpreted as a state in which the UE200 cannot immediately utilize the SCG (SCell), but configuration information is retained.

In this embodiment, the channel includes a control channel and a data channel. The control channel includes PDCCH (Physical Downlink Control Channel), PUCCH (Physical Uplink Control Channel), PRACH (Physical Random Access Channel), PBCH (Physical Broadcast Channel), and the like.

The data channel includes PDSCH (Physical Downlink Shared Channel), PUSCH (Physical Uplink Shared Channel), and the like.

The reference signal includes Demodulation Reference Signal (DMRS), Sounding Reference Signal (SRS), Phase Tracking Reference Signal (PTRS), and Channel State Information-Reference Signal (CSI-RS), and the signal includes the channel and the reference signal. The data may mean data transmitted via the data channel.

### (2.2) UE200

FIG. 3 is a functional block diagram of the UE200. As shown in FIG. 3, the UE200 includes a radio communication unit 210, an RRC processing unit 220, a DC processing unit 230, and a control unit 240.

The radio communication unit 210 transmits an uplink signal (UL signal) in accordance with LTE or NR. The radio communication unit 210 receives a downlink signal (DL signal) in accordance with LTE or NR.

In other words, the UE200 can access the eNB100A (E-UTRAN20) and the gNB100B (NG RAN30) and can support dual connectivity (Specifically, EN-DC). Thus, the UE200 can transmit and receive radio signals via the MCG or SCG, specifically via cells included in the MCG or cells included in the SCG (SCell including PSCell).

The radio communication unit 210 performs assembly/disassembly of the PDU/SDU in the MAC, RLC, PDCP, etc., in the same manner as the radio communication unit 110 of the eNB100A (gNB100B).

The RRC processing unit 220 executes various processes in a radio resource control layer (RRC). Specifically, the RRC processing unit 220 can transmit and receive messages in the radio resource control layer.

The RRC processing unit 220 can receive RRC Reconfiguration from the network, specifically, from the E-UTRAN20 (or NG RAN30). The RRC processing unit 220 can send RRC Reconfiguration Complete, which is a response to RRC Reconfiguration, to the network.

The DC processing unit 230 executes processing related to dual connectivity, specifically, MR-DC. As described above, in this embodiment, the DC processing unit 230 may execute processing related to EN-DC, but may correspond to NE-DC and/or NR-DC.

The DC processing unit 230 can access each of the eNB100A and the gNB100B and execute configurations in a plurality of layers (Media access control layer (MAC), radio link control layer (RLC), packet data convergence protocol layer (PDCP), etc.) including the RRC.

The DC processing unit 230 can transmit a report on deactivation of the SCG. The report on deactivation may be broadly interpreted and may include a configuration for activation or deactivation of the SCG, an explicit or implicit indication of an active or de-active state, and a transition to the state.

The DC processing unit 230 may also transmit SCG failure information to the network. Specifically, the DC processing unit 230 may transmit an SCGFailureInformationmessage (or a new RRC message) via the RRC processing unit 220. In this embodiment, the DC processing unit 230 may constitute a transmission unit. SCGFailureInformation is specified in 3GPP TS38.331.

Specifically, when a failure of a deactivated SCG (SCG) in an inactive state occurs, the DC processing unit 230 may transmit failure information (SCGFailureInformation) including an information element indicating the state of a cell in the SCG. The cell in the deactivated SCG may be interpreted as a cell included in the deactivated SCG, and may typically be interpreted as a SCell including a PSCell. The information element (IE) is a component of SCGFailureInformation that may include letters, numbers, symbols, etc., and may be referred to as a field, etc.

The DC processing unit 230 may transmit SCGFailureInformation containing at least one of identification information (FailedCellID) of a failed cell (PSCell, etc.) and the cause for the failure in the deactivated SCG. The FailedCellID is not particularly limited to physical cell ID, etc., as long as the information can identify the cell. The cause for the failure is the cause for the failure of the deactivated SCG, including expiration of the associated timer (T310/T312, detailed below) or failure of the initial access, specifically the random access (PA) procedure.

The DC processing unit 230 may also transmit SCGFailureInformation containing at least either the state of the transmission timing adjustment timer or the elapsed time since the SCG was deactivated.

The state of the transmission timing adjustment timer may be, for example, the elapsed time (time from the start of the timer) of the time alignment timer (TA timer), but the elapsed time may be indicated directly, or the range may be indicated by dividing it into a predetermined range. The transmission timing adjustment may be interpreted as delaying or advancing the transmission timing of the UL signal based on a predetermined reference timing.

The DC processing unit 230 may transmit SCGFailureInformation including the reception quality in the serving cell and neighboring cell (Neighbor cell).

The reception quality may include RSRP (Reference Signal Received Power), RSRQ (Reference Signal Received Quality) and SINR (Signal-to-Interference plus Noise power Ratio). RSRP is the reception level of the reference signal measured at UE200, and RSRQ is the reception quality (May be interpreted as the ratio of the power of the cell-specific reference signal to the total power in the received bandwidth) of the reference signal measured at UE200.

Note that the serving cell may simply be interpreted as a cell to which UE200 is connected, but more specifically, in the case of a UE of RRC_CONNECTED in which carrier aggregation (CA) is not set, only one serving cell constitutes the primary cell. In the case of a UE of RRC_CONNECTED configured using CA, the serving cell may be interpreted as indicating a set of one or more cells including the primary cell and all secondary cells.

The DC processing unit 230 may transmit SCGFailureInformation containing the contents related to the execution result of the initial access. Specifically, the DC processing unit 230 may include the contents related to the execution result of the initial access executed while the SCG is deactivated in SCGFailureInformation.

For example, the DC processing unit 230 may include a display (For example, fallbackToCBRA (tentative name)) in SCGFailureInformation indicating that the execution of the contention-free random access procedure (CFRA) has failed and fallen back to the contention-free random access procedure (CBRA).

The DC processing unit 230 may also include a display in SCGFailureInformation indicating that the execution of the 2-step RACH has fallen back to the 4-step RACH. In addition, a display indicating the quality of the DL beam when the RA procedure is attempted while the SCG is deactivated or whether the quality of the DL beam exceeds a predetermined threshold may be included in SCGFailureInformation.

Only a part or all of the information elements related to the deactivated SCG described above may be included in SCGFailureInformation.

The control unit 240 controls each functional block constituting the UE200. In particular, in this embodiment, the control unit 240 can perform control on the activation/deactivation (active/de-active) of the secondary cell group (SCG).

Specifically, the control unit 240 deactivates the SCG according to the state of the SCG. More specifically, the control unit 240 may deactivate the SCG when the timer related to the reconfiguration of the radio resource expires in the SCG. The timer related to the reconfiguration of the radio resource may be interpreted as a timer related to the reconfiguration of the RRC.

The timer may be T304, T310 or T312 as defined in 3GPP TS38.331. control unit 240 may deactivate the SCG when these timers expire.

Timer T304 may be started upon receipt of an RRC Reconfiguration message containing reconfigurationWithSync, or upon execution of a conditional reconfiguration, that is, upon application of a stored RRC Reconfiguration message containing reconfigurationWithSync, and stopped upon successful completion of random access on the corresponding SpCell.

The timer T310 may be stopped when it detects a problem with the physical layer of the Special Cell (SpCell), that is, when it receives a contiguous out of synchronization display of N310 from a lower layer, when it receives a contiguous synchronous display of N311 from a lower layer of the SpCell, when it receives RRC Reconfiguration with reconfigurationWithSync of the cell group, when it receives MobilityFromNRCommand, when it reconfigures rlf-TimersAndConstant, when it starts the connection reestablishment procedure, when it starts the MCG failure information procedure, and when it releases the SCG.

T312 is initiated if T312 is configured with MCG and during PCell's T310 run, T312 is configured and triggers a measurement report for a measurement ID with “useT312” set to true.

T312 is configured with SCG and “useT312” is set to true and may be initiated if during PSCell's T310 run, T312 triggers a measurement report for a configured measurement ID.

Also, T312 may be stopped when it receives an N311 continuous synchronization display from a lower layer of SpCell, when it receives an RRC Reconfiguration in reconfigurationWithSync of the cell group and initiates a connection reestablishment procedure, when it reconfigures rlf-TimersAndConstant, when it initiates an MCG failure information procedure, and when T310 expires in the corresponding SpCell.

The control unit 240 may also deactivate the SCG if an initial access procedure problem occurs. The initial access procedure may be interpreted as a procedure performed to connect the idle UE200 to a cell included in the SCG, as described above, and may be a random access (RA) procedure.

Specifically, the control unit 240 may deactivate the SCG if the MAC layer of the SCG provides a random access problem indication of the RA procedure (which may be a RACH transmission).

The deactivated state of the SCG may be at least any of the following states.
The PUSCH is not transmitted in the deactivated SCG.
The PDCCH is not monitored in the PSCell of the deactivated SCG.
SCell dormancy is not supported for SCells in deactivated SCGs.
UE200 keeps DL synchronized.
The UE200 performs the Restricted RRM measurement.
PSCell mobility is supported.
UE200 performs limited radio link monitoring (RLM) and/or does not perform beam management (beam fault detection and recovery), SRS(Sounding Reference Signal) transmission, CSI report.

### (3) Operation of Radio Communication System

Next, the operation of radio communication system 10 will be described. Specifically, the operation related to the activation/deactivation (active/de-active) of the secondary cell group (SCG) will be described. More specifically, the operation of the UE200 when a failure of the deactivated SCG is detected will be mainly described.

### (3.1) Communication Sequence Example

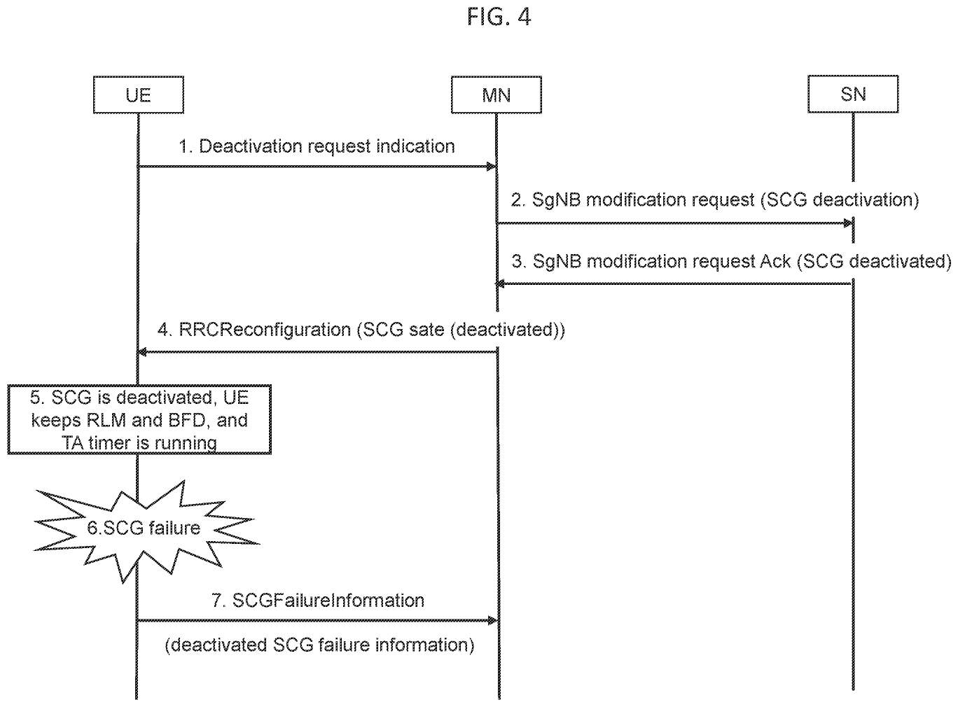

FIG. 4 shows a communication sequence example associated with SCG deactivation and SCG failure detection. In this operation example, radio link monitoring (RLM) and beam failure detection (BFD) by UE200 may be supported in the deactivated SCG. In other words, UE200 may maintain the functions of RLM and BFD even if SCG is deactivated.

In addition, when the UE200 detects a radio link failure (RLF) in the PSCell in the deactivated SCG state, it may transmit SCGFailureInformation, a RRC layer message, to the MN (For example, eNB100A).

As shown in FIG. 4, the UE200 requests the MN to deactivate the SCG (step 1). Based on the request, the MN sends an SgNB modification request (SCG deactivation) to the SN (For example, gNB100B) (step 2). This starts the process of deactivation of the SCG.

The SN deactivates the SCG and returns the SgNB modification request Ack (SCG deactivated), which is a response to the SgNB modification request (step 3).

Based on the received SgNB modification request Ack, the MN sends the RRC Reconfiguration (SCG state (deactivated)) to the UE200 (step 4).

The UE200 recognizes that the SCG has been deactivated (step 5). However, the UE200 maintains the RLM and BFD. The TA timer also continues to operate without stopping.

Thereafter, a failure occurs in the deactivated SCG (step 6). Specifically, the UE200 detects the expiration of the T310/T312 or the failure of the RACH as described above, and determines that a failure has occurred in the SCG.

Upon detecting the failure of the SCG, the UE200 transmits SCGFailureInformation to the MN (step 7). The SCGFailureInformation may include an information element about the deactivated SCG as described above. Details of the information elements contained in SCGFailureInformation are described below.

### (3.2) Contents of SCGFailureInformation

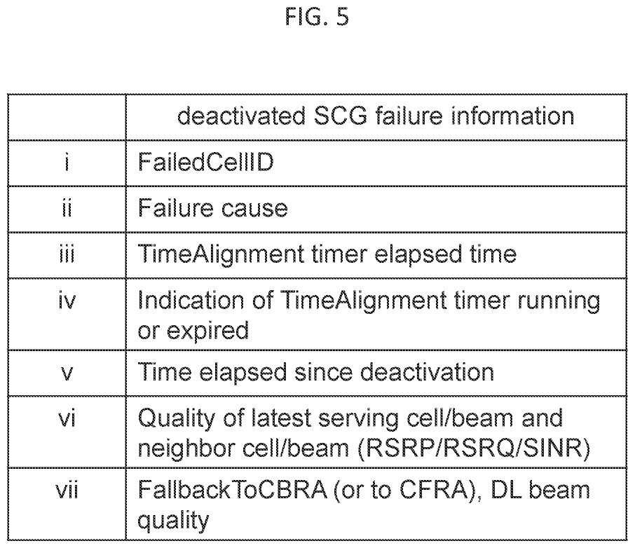

FIG. 5 shows an example of information elements about deactivated SCG that can be included in SCGFailureInformation.

The SCGFailureInformation sent in step 7 of FIG. 4 may include the following information elements (May be called deactivated SCG failure information):

(i) Identification of the failed cell (PSCell) (FailedCellID)

(ii) Failure cause

May include indication of deactivated SCG side radio link failure (T310/T312 expired), reconfigurationWithSync (T304 expired), RA procedure (RACH) failure, beam failure/recovery (beamFailureIndication/beamFailureRecoveryFailure), or scg-ListenBeforeTalkFailure.

It should be noted that the LBT may be interpreted as a mechanism that enables transmission within a predetermined time period only when the radio base station (For example, eNB100A) performs carrier sensing and confirms that the channel is not being used by other nearby systems, and may be applied in an unlicensed frequency band that does not require administrative license assignment and can be used without being limited to a specific carrier. Such a procedure involving the LBT may be referred to as a channel access procedure.

(iii) Elapsed time of the TA timer

By including the elapsed time of the TA timer (time since startup), the network can leverage the TA timer configuration for UE200.

(iv) indication of the TA timer state (running or expired) at the time of SCG failure

The inclusion of the TA timer state (running/expired) allows the network to recognize whether UE200 has been able to establish UL synchronization.

(v) At UE200, the time elapsed between the transition of the SCG to the inactive state and the detection of the failure of the SCG (time elapsed since deactivation), or the time elapsed between the receipt of the SCG deactivation instruction and the detection of the failure of the SCG by RRC Reconfiguration/MAC CE (Control Element).

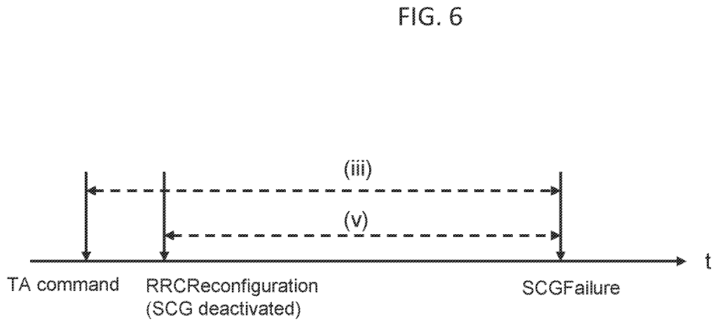

FIG. 6 shows an example of the elapsed time of the TA timer and the time elapsed between the transition of the SCG to the inactive state and the detection of the failure of the SCG.

As shown in FIG. 6, the elapsed time (iii) of the TA timer may be interpreted as the time elapsed between the reception of the TA command by the UE200 and the detection of the failure of the SCG. The elapsed time (v) between the transition of the SCG to the inactive state and the detection of the failure of the SCG may be interpreted as, for example, the time elapsed between the reception of the RRC Reconfiguration by the UE200 and the detection of the failure of the SCG.

(vi) When the SCG is in the inactive state, the reception quality (Receive quality of latest serving cell/beam and neighbor cell/beam) of the latest serving cell and neighboring cell immediately before the detection of the failure of the SCG.

The serving cell and neighboring cell may include the beam of the cell. As described above, the reception quality may include at least one of RSRP, RSRQ and SINR.

This information element takes into consideration that, in the inactive state of the SCG, the RRM (Radio Resource Management) measurement is relaxed, so that the result of the normal RRM measurement is assumed to be different.

(vii) Contents related to the execution result of the initial access (PA) procedure

Since DL synchronization and RLM/beam monitoring are relaxed in the inactive state of the SCG, contention-free RACH (CFRA) may not be possible.

The UE200 may include an indication that it has fallen back to contention-free RACH (CBRA) (For example, fallbackToCBRA) or from 2-step to 4-step RACH if the dedicated RACH resource is set and the CFRA attempt is unsuccessful.

The UE200 may also include an indication that when the SCG is inactive and a RACH transmission is attempted, the DL beam quality at the time of the RACH transmission and/or whether the DL beam quality has exceeded a predetermined threshold.

### (4) Operational Effects

According to the above-described embodiment, the following effects can be obtained. Specifically, the UE200 can provide the SCGFailureInformation including appropriate information elements utilizing the results of RLM and/or BFD to the network in the event of a deactivated SCG failure in the MR-DC.

Thus, the network can easily optimize the configuration of various parameters associated with the UE200 utilizing the information elements.

In particular, in this embodiment, the information elements (i)-(vii) described above can be provided to the network upon the occurrence of a failure of the deactivated SCG. Therefore, the network (operator) can use the information to contribute to the quality improvement of the cells or beams included in the SCG.

### (5) Other Embodiments

Although the contents of the present invention have been described by way of the embodiments, it is obvious to those skilled in the art that the present invention is not limited to what is written here and that various modifications and improvements thereof are possible.

For example, in the above-described embodiment, the information elements (i) to (vii) are included in the SCGFailureInformation which is a message of the RRC, but if the failure information of the SCG is a message other than the RRC (For example, MAC or lower layer signaling (such as DCI)), the information element may be reported to the network.

In the foregoing description, setting (configure), activating (activate), updating (update), indicating (indicate), enabling (enable), specifying (specify), and selecting (select) may be mutually interpreted. Similarly, link, associate, correspond, and map may be mutually interpreted, and allocate, assign, monitor, and map may be mutually interpreted.

In addition, specific, dedicated, UE-specific, and UE-specific may be mutually interpreted. Similarly, common, shared, group-common, UE-common, and UE-shared may be mutually interpreted.

Further, block configuration diagrams (FIGS. 2 and 3) used in the description of the above-described embodiment show blocks of functional units. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that functions transmission is called a transmission unit (transmitting unit) or a transmitter. As described above, the method of realization of both is not particularly limited.

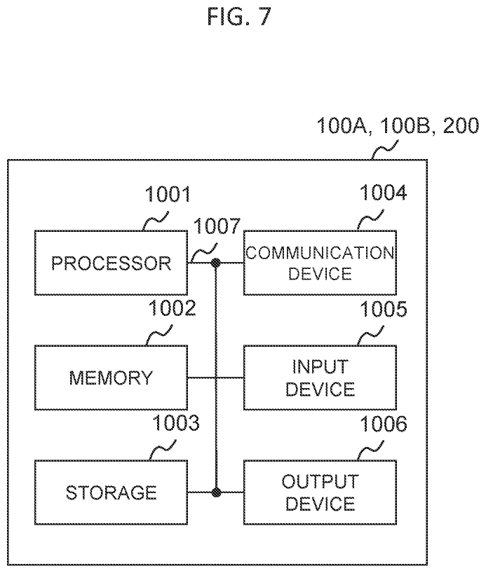

Furthermore, the above-mentioned eNB100A, gNB100B and UE200 (the device) may function as a computer for processing the radio communication method of the present disclosure. FIG. 7 is a diagram showing an example of a hardware configuration of the device. As shown in FIG. 7, the device may be configured as a computer device including a processor 1001, a memory 1002, a storage 1003, a communication device 1004, an input device 1005, an output device 1006 and a bus 1007.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 2.3) is implemented by any hardware element or combination of hardware elements of the computer device.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

Processor 1001, for example, operates an operating system to control the entire computer. Processor 1001 may be configured with a central processing unit (CPU), including interfaces to peripheral devices, controls, computing devices, registers, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), or the like. The memory 1002 may store a program (program code), a software module, or the like capable of executing a method according to an embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device, such as the processor 1001 and the memory 1002, is connected by a bus 1007 for communicating information. The bus 1007 may be configured using a single bus or a different bus for each device.

In addition, the device may be configured to include hardware such as a microprocessor, a digital signal processor (DSP), an application specific integrated circuit (ASIC), a programmable logic device (PLD), a field programmable gate array (FPGA), or the like, which may provide some or all of each functional block. For example, the processor 1001 may be implemented by using at least one of these hardware.

Further, the notification of information is not limited to the aspects/embodiments described in the present disclosure and may be carried out using other methods. For example, the notification of information may be performed by physical layer signaling (e.g., Downlink Control Information (DCI), Uplink Control Information (UCI), higher layer signaling (e.g., RRC signaling, Medium Access Control (MAC) signaling, Notification Information (Master Information Block (MIB), System Information Block (SIB)), other signals or combinations thereof. RRC signaling may also be referred to as RRC messages, e.g., RRC Connection Setup messages, RRC Connection Reconfiguration messages, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing steps, sequences, flowcharts, etc., of each of the embodiments/embodiments described in the present disclosure may be reordered as long as there is no conflict. For example, the method described in the present disclosure presents the elements of the various steps using an exemplary sequence and is not limited to the particular sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from a higher layer (or lower layer) to a lower layer (or higher layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the embodiments/embodiments described in the present disclosure may be used alone, in combination, or alternatively with execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channels and symbols may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, planes, etc.), an unmanned mobile (For example, drones, self-driving cars), or a robot (manned or unmanned). At least one of a base station and a mobile station can be a device that does not necessarily move during the communication operation. For example, at least one of a base station and a mobile station may be an Internet of Things (IoT) device such as a sensor.

The base station in the present disclosure may be read as a mobile station (user terminal, hereinafter the same). For example, each aspect/embodiment of the present disclosure may be applied to a configuration in which communication between a base station and a mobile station is replaced by communication between a plurality of mobile stations (For example, it may be called device-to-device (D2D), vehicle-to-everything (V2X), etc.). In this case, the mobile station may have the function of the base station. Further, words such as “up” and “down” may be replaced with words corresponding to communication between terminals (For example, “side”). For example, terms an uplink channel, a downlink channel, or the like may be read as a side channel.

Similarly, the mobile station in the present disclosure may be replaced with a base station. In this case, the base station may have the function of the mobile station.

A radio frame may be composed of one or more frames in the time domain.

Each frame or frames in the time domain may be referred to as a subframe. A subframe may be further configured by one or more slots in the time domain.

The subframe may have a fixed time length (e.g., 1 ms) that does not depend on the numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in units of time greater than the minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframes and TTI may be a subframe in an existing LTE (1 ms), a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots (number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain.

The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (SubCarrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB relative to the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to send and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgment” and “decision” may include regarding some action as “judgment” and “decision.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.”

Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 E-UTRAN
30 NG RAN
100A eNB
100B gNB
110 radio communication unit
120 RRC processing unit
130 DC processing unit
140 control unit
200 UE
210 radio communication unit
220 RRC processing unit
230 DC processing unit
240 control unit
1001 processor
1002 memory
1003 storage
1004 communication device
1005 input device
1006 output device
1007 bus

1. A terminal comprising:
a control unit that deactivate a secondary cell group according to a state of the secondary cell group; and
a transmission unit that transmits failure information of the secondary cell group to a network,
wherein the transmission unit transmits, when a failure of the secondary cell group in an inactive state occurs, the failure information including an information element indicating a state of cells of the secondary cell group.

2. The terminal according to claim 1, wherein the transmission unit transmits the failure information including at least one of identification information of the failed cell and a cause for the failure.

3. The terminal according to claim 1, wherein the transmission unit transmits the failure information including at least one of a state of a transmission timing adjustment timer and an elapsed time since deactivating the secondary cell group.

4. The terminal according to claim 1, wherein the transmission unit transmits the failure information including reception quality of the serving cell and neighboring cell.

5. The terminal according to claim 1, wherein the transmission unit transmits the failure information including content related to execution result of an initial access.

6. A radio communication method comprising the steps of:
a terminal deactivating a secondary cell group according to a state of the secondary cell group; and
the terminal transmitting failure information of the secondary cell group to a network,
wherein in the transmitting step, when a failure of the secondary cell group in an inactive state occurs, the failure information including an information element indicating a state of cells of the secondary cell group is transmitted.

7. The terminal according to claim 2, wherein the transmission unit transmits the failure information including reception quality of the serving cell and neighboring cell.

8. The terminal according to claim 3, wherein the transmission unit transmits the failure information including reception quality of the serving cell and neighboring cell.

9. The terminal according to claim 2, wherein the transmission unit transmits the failure information including content related to execution result of an initial access.

10. The terminal according to claim 3, wherein the transmission unit transmits the failure information including content related to execution result of an initial access.

11. The terminal according to claim 4, wherein the transmission unit transmits the failure information including content related to execution result of an initial access.
